(19) United States
(12) Patent Application Publication
(10) Pub. No.: US 2005/0132101 A1
(43) Pub. Date: Jun. 16, 2005

(54) Data switch

(76) Inventors: Chris McEvilly, Bagshot, Surrey (GB); Shaheedur Reza Hague, London (GB); Richard Andrew Morrell, Lower Wortley (GB)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/493,928

(22) PCT Filed: Oct. 22, 2002
(86) PCT No.: PCT/GB02/04747

(30) Foreign Application Priority Data
Oct. 23, 2001 (GB) 0125420.0

(51) Int. Cl. G06F 3/00

(52) U.S. Cl. 710/36

(57) ABSTRACT

A data switch is provided which can be used, for example, to control the delivery of a number of video streams to a plurality of users. The data switch operates to receive the incoming data streams and temporarily stores them in a buffer. The data switch receives requests from users identifying the data stream that each user wishes to receive. The data switch then reads out the data from the buffer to each of the users in accordance with their selection.

The present invention relates to a data switch and the methods of its use to control the distribution of one or more data streams to a number of target devices. The data switch can be used, for example, as part of a video delivery system to facilitate the delivery of video streams to a number of different users. The invention also relates to a data switch which can allow the incorporation of personalised content into data streams for delivery to different users.

Conventionally, television programmes have been broadcast to users via RF signals transmitted from terrestrial base stations, via signals transmitted from overhead satellites and via signals transmitted over cable to user premises. Each of these systems offers the user the ability to watch a number of different channels which can be selected by the user. These existing systems, however, require all of the channels to be transmitted to the user's television receiver, which then tunes into and displays one of the channels in accordance with the user's selection. Whilst this conventional technique is cost effective, it requires the use of a significant amount of bandwidth and does not allow for the transmission of personalised content to each user since each user receives the same channels.

In some of these conventional systems the user must subscribe to the service provider in order to be able to view some of the channels. However, since each user's television receiver receives all of the channels, users can still gain access to restricted channels using appropriate hacking equipment which can bypass the service provider's security.

Television broadcasters have also provided television channels over data networks to computers provided in users' homes. To be able to work effectively, these systems use a different protocol to transmit the audio and video data to that conventionally used to send, for example, e-mail over the Internet. In particular, these systems use a streaming protocol (such as UDP (User Datagram Protocol)) which allows some packets to be lost in the transmission process without the transmission stopping and restarting. There are currently two types of such data network video systems—one in which users directly receive a dedicated video stream from the video server and one in which a common video stream is transmitted from the video server using multi-cast techniques to duplicate the video stream for each of the users which is a party to the multi-cast transmission. The problem with the first approach is that it requires significant bandwidth between the video server and each user and the problem with the second approach is that it does not provide a truly one-to-one relationship between the user and the video server and hence limited personalisation of the video stream for each user can be achieved.

According to one aspect, the present invention provides a data switch which can be used, for example in the Internet, to control the delivery of a number of streams of data to a number of different users. The data streams may be representative of, for example, a video and/or an audio signal and may include personalised content such as an advert or the like. In the preferred embodiment, the data switch receives a number of incoming broadcast streams, efficiently selects the streams of interest and distributes them to the appropriate users. The selection of the streams of interest and their distribution is efficiently performed by the data switch in response to external commands provided by, for example, the users.

According to another aspect, the present invention provides a data switch for controlling the distribution of a plurality of data streams to one or more target devices, the data switch comprising: a buffer for receiving and storing data for each of a plurality of data streams; and a distributor for cyclically processing the data in the buffer to distribute, during each processing cycle, portions of the data streams to one or more target devices in accordance with stored distribution data which identifies which one or more data streams should be distributed to the or each target device.

According to another aspect, the present invention provides a data switch for controlling the distribution of a plurality of data streams to one or more target devices, the data switch comprising an input interface unit for receiving the plurality of data streams; buffer means for receiving and storing data from each of the received data streams from the input interface unit; a distributor for processing the data in the buffer to distribute the data streams to the one or more target devices in accordance with stored distribution data identifying which one or more data streams should be distributed to the or each of said target devices; and wherein the input interface unit is operable to group the data for each data stream into fixed sized blocks and to store the blocks for each data stream at predetermined memory locations within said buffer means and wherein the distributor is operable to read said blocks from the predetermined memory locations within the buffer during the distribution of the data streams to said one or more target devices.

According to another aspect, the present invention provides a data switch for controlling the distribution of a plurality of data streams to one or more target devices, the data switch comprising: a buffer for receiving and storing data from each of the received data streams; means for storing a current distribution list identifying which one or more data streams should be distributed to the or each target device at a current time point; means for storing a next distribution list identifying which one or more data streams should be distributed to the or each of said target devices at a next time point; a distributor responsive to the current stored distribution list for processing the data in the buffer to distribute the data streams to the one or more users in accordance with the current stored distribution list; and means for intermittently setting said next distribution list as said current distribution list to cause said distributor to change the way in which said data streams are distributed to said one or more target devices.

As mentioned above, the data switches described above can be used to control the distribution of data streams to one or more target devices. Since each target device receives a dedicated stream from the data switch, it is possible to personalise the data streams at the data switch. This may be done, for example, by adding personalised data into each stream, which personalised data may be stored locally to the data switch. The personalised data may be, for example, advert data which can be updated from time to time from a central store. Alternatively, one or more of the data streams transmitted to the users may be temporarily stored in a hard disc or the like providing the user with the ability to pause, fast-forward and rewind through the stored data stream.

Other features and aspects of the invention will become clear from the detailed description of the exemplary embodiments given below with reference to the accompanying drawings in which:

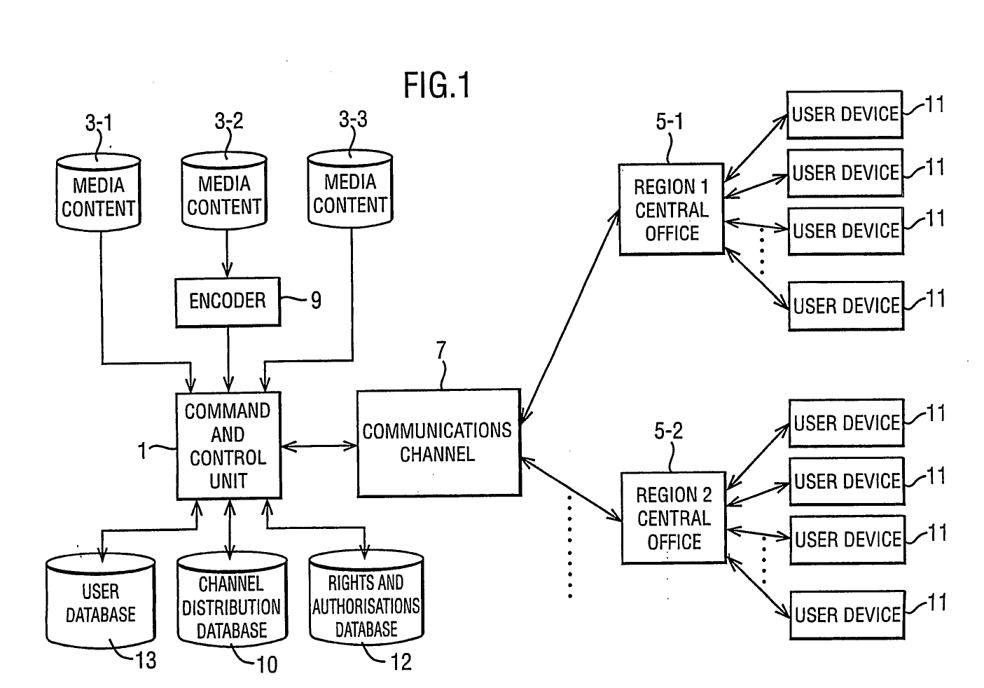

FIG. 1 is a schematic block diagram of a data distribution system;

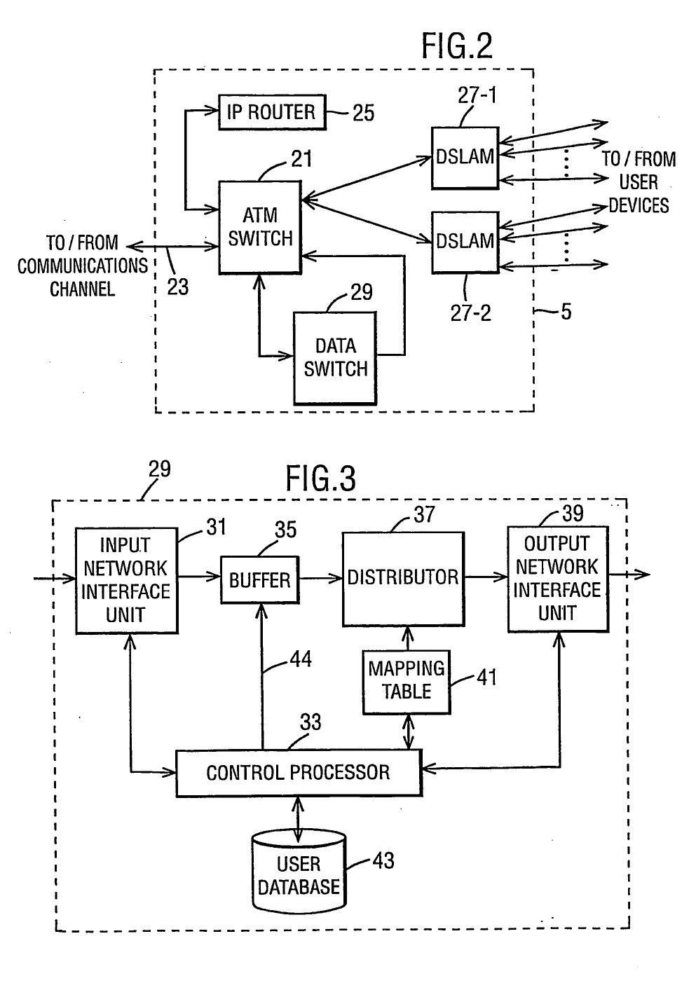

FIG. 2 is a block diagram of a central office forming part of the data distribution system shown in FIG. 1;

FIG. 3 is a block diagram illustrating the main components of a data switch which forms part of the central office shown in FIG. 2;

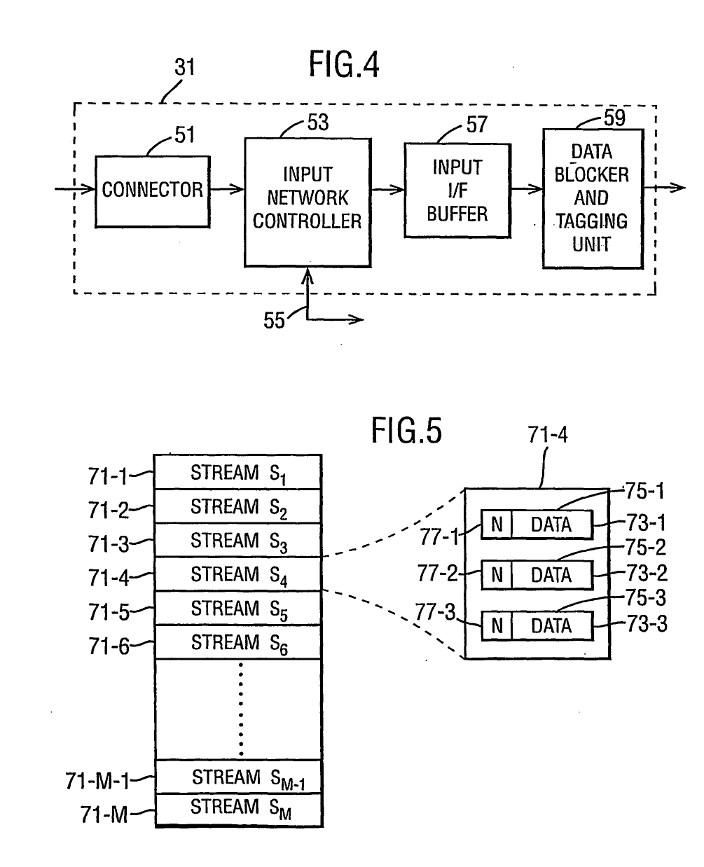

FIG. 4 is a block diagram illustrating the main components of an input network interface unit which forms part of the data switch shown in FIG. 3;

FIG. 5 is a schematic diagram illustrating the way in which data is stored in a buffer forming part of the data switch shown in FIG. 3;

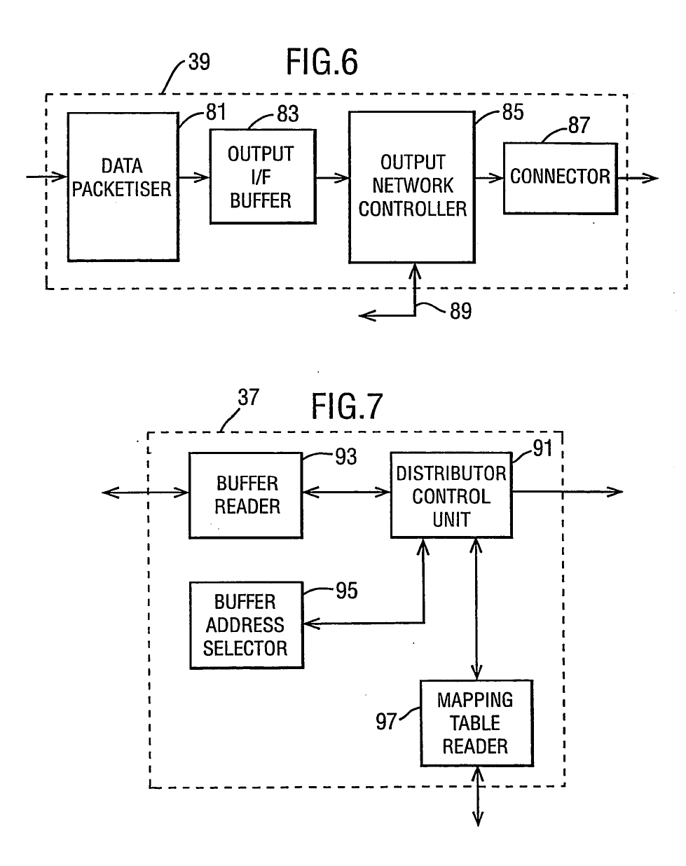

FIG. 6 is a block diagram illustrating the main components of an output network interface unit forming part of the data switch shown in FIG. 3;

FIG. 7 is a block diagram illustrating the main components of a distributor which forms part of the data switch shown in FIG. 3;

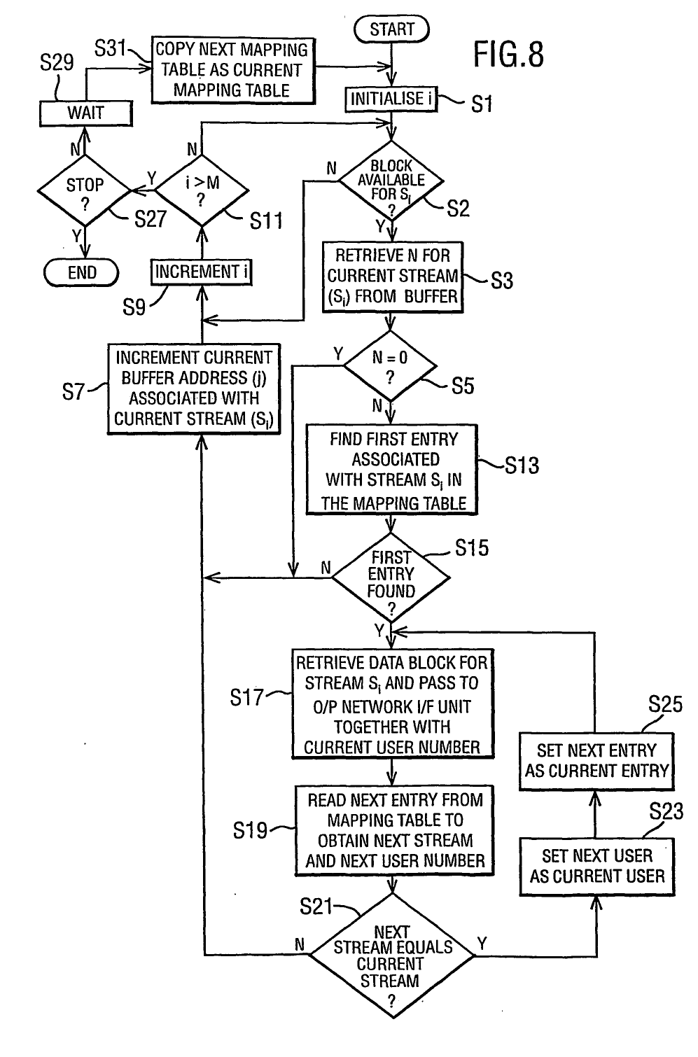

FIG. 8 is a flowchart illustrating the operation of the distributor shown in FIG. 7;

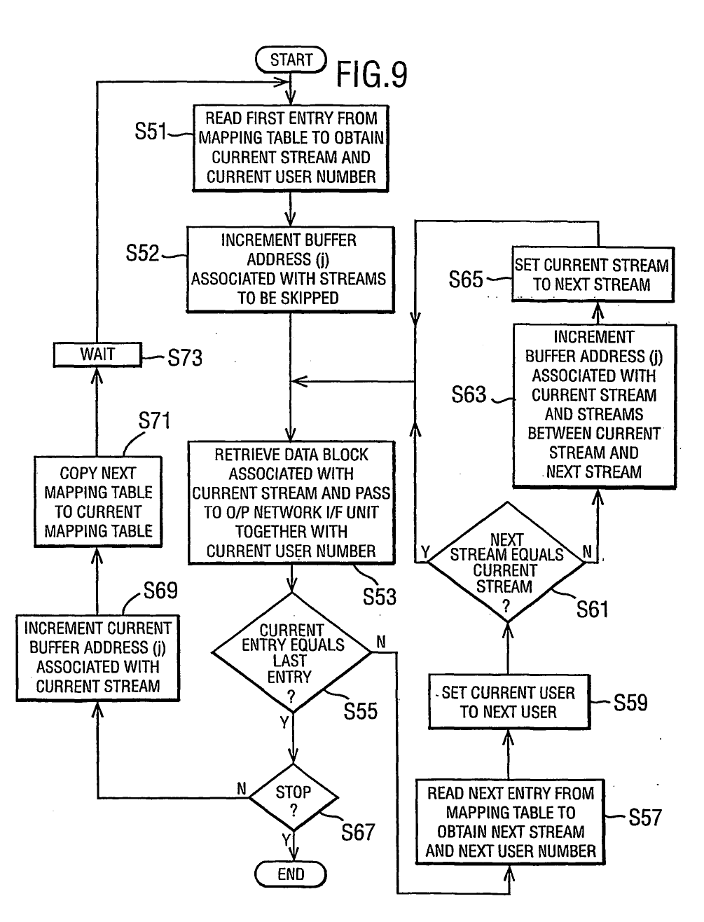

FIG. 9 is a flowchart illustrating an alternative operation of the distributor shown in FIG. 7;

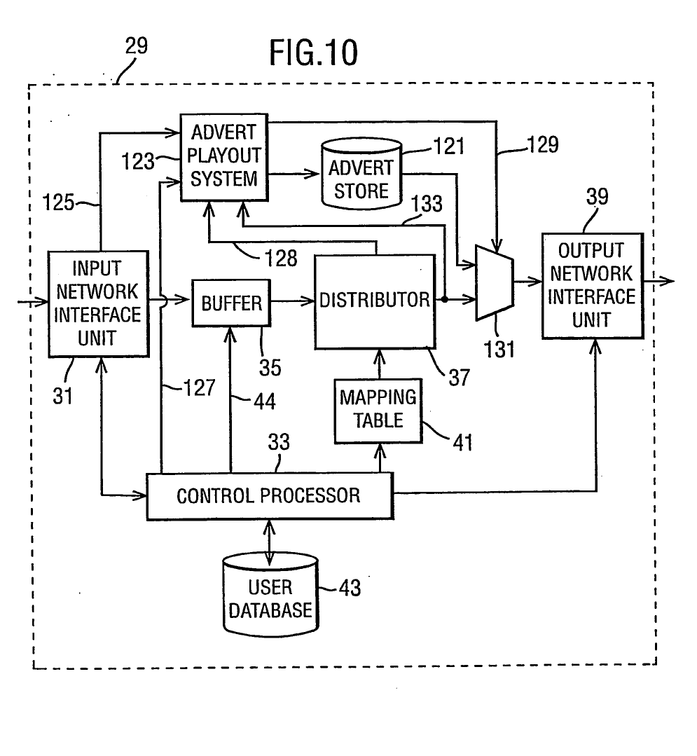

FIG. 10 is a block diagram illustrating the main components of a data switch according to an alternative embodiment;

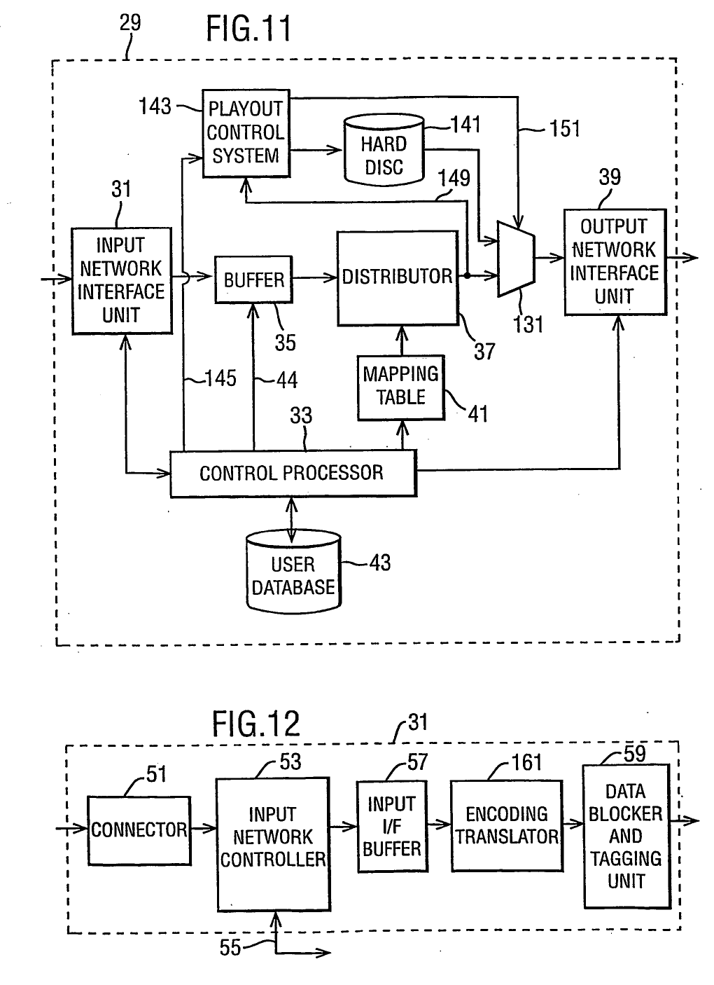

FIG. 11 is a block diagram illustrating the main components of another data switch embodying the present invention; and

FIG. 12 is a block diagram illustrating the main components of an alternative input network interface unit which may be used in the data switch shown in FIGS. 3, 10 or 11.

### OVERVIEW

FIG. 1 is a schematic block diagram of a data broadcast system for supplying data signals (in this embodiment video signals for a plurality of television channels) to a plurality of remote users. As shown in FIG. 1, the system comprises a command and control unit 1 which receives video signals from a number of different media content sources 3-1, 3-2 and 3-3 and which transmits these video signals to a number of geographically distributed central offices 5-1, 5-2 via a communications channel 7. In this embodiment, each video signal is transmitted as a digital data stream over the communications channel 7, with the data in each stream marked to identify the stream to which it belongs. In this embodiment, the video signals received from the media content sources 3-1 and 3-3 are digital streams whereas the video signals received from the media content source 3-2 are analogue signals. An appropriate encoder 9 is therefore provided between the media content source 3-2 and the command and control unit 1 for converting the analogue video signals into appropriate digital video signals in, for example, MPEG format.

The central offices 5 are arranged to receive all or a proportion of the video streams transmitted from the data sources 3 as commanded by the command and control unit 1 which determines the streams to be transmitted to each central office based on data stored in a channel distribution database 10 and a rights and authorisations database 12. The channel distribution database 10 stores data defining which video streams are to be distributed to which central offices 5 and the rights and authorisations database stores data defining any restrictions on, for example, the times at which video streams may be distributed (for example, video streams having an adult theme may be prohibited from being. distributed at certain times of the day). Upon receiving the transmitted streams, the central offices 5 forward the video streams to the user devices 11 connected therewith in accordance with user selections. In particular, the central offices 5 receive user requests from the connected user devices 11 indicating the desired video streams for those users but only sends the requested video data streams to those users if they are allowed access to them. In this embodiment, this user access information is stored locally within a data switch (not shown) at each central office 5. The data switch in each central office 5 only stores the user access information for the users to which it delivers video data. The user access information for all of the users served by all of the central offices 5 is stored within a central user database 13 maintained by the command and control unit 1. From time to time the locally stored user access information is updated by the command and control unit 1 using the data within the central user database 13.

In this embodiment, the central offices 5 also transmit data back to the command and control unit 1 via the communications channel 7 detailing which video stream each user requests, the time of the requests and the time that each user stops receiving a video stream. This information is then used by the command and control unit 1 for billing purposes and for updating profiles of each user which are stored in the user database 13. For example, the command and control unit 1 can statistically analyse the viewing habits of all of the users to detect patterns in the users' behaviour and to determine the types of video streams each user likes to watch and those that each user dislikes. This information can then be used, for example, to provide each user with a tailor-made menu of video streams that the user may like to watch. The information received from each of the central offices 5 can also be used for collecting ratings information and for planning the content of the data streams for future delivery. For example, the analysis may identify that in one geographical region none of the users watch a particular type of video stream. The command and control unit 1 can therefore use this information to stop distributing that type of video stream to the central office 5 for that geographical region.

One of the novel features of the present invention is the way in which the central offices 5 receive the incoming video streams and distributes the appropriate video stream to each user. The description of the way in which the central offices 5 operate will now be described in more detail for an embodiment in which the video streams are transmitted as MPEG data over UDP over IP (Internet Protocol) over ATM (Asynchronous Transfer Mode) to the central offices 5 and then transmitted from the central offices 5 to the users as MPEG data over UDP over IP over Asymmetric Digital Subscriber Lines (ADSLs). In other words, the MPEG data packets transmitted to the central offices 5 include UDP header data, IP header data and ATM header data and the data transmitted to the user devices 11 is transmitted together with a UDP header, an IP header and transmitted in a form suitable for transmission over an ADSL.

### Central Office

FIG. 2 is a block diagram illustrating the main components of one of the central offices 5 used in this embodiment. As shown, the central office 5 includes an ATM switch 21 which receives conventional data packets and the video stream packets on the data link 23. The switch 21 distinguishes the different types of received data packets using addressing information contained within the header of each data packet. The conventional data packets are switched to an IP router 25 which looks at the headers of each packet that it receives and routes them to the appropriate user devices 11 via the corresponding DSLAM (Digital Subscriber Line Access Multiplexer) 27-1 or 27-2. The video data packets are switched directly to the data switch 29 as directed by the command and control unit 1.

In this embodiment, the central offices 5 also receive data from the user devices 11 connected thereto. The ATM switch 21 is arranged so that user requests relating to the delivery of a particular video stream are directed to the data switch 29 whereas all other user generated data is delivered to the IP router 25 which forwards them as required. In this embodiment, this is achieved by providing a dedicated virtual circuit between each user device 11 and the data switch 29. This virtual circuit may be provided, for example either by providing a dedicated time slot within the communications link between the user device 11 and the ATM switch 21 or by providing a dedicated frequency channel. In either case, the user requests relating to the delivery of the video will be delivered directly to the data switch 29 without the ATM switch 21 having to switch the requests via the IP router 25.

In this embodiment, in addition to the video data packets and the user request data packets which are received by the data switch 29, management data is also transmitted between the control processor 33 and the command and control unit 1 via the IP router 25. This management data is used in order to maintain and update the user profiles stored in the user database 43 and to identify to the control processor 33 the different video streams which it will receive and which it can therefore distribute to the users. The control processor 33 also logs each time that a user starts watching a video stream, changes video stream and stops watching a video stream. As mentioned above, this information is passed back to the command and control unit 1 for user billing, user profiling etc.

As will be described in more detail below, the data switch therefore operates: (i) to receive the video data packets and the user request data packets; (ii) to process the video data packets to distribute them to the. appropriate users in accordance with the received user requests; and (iii) to communicate with the command and control unit 1 to maintain up-to-date user profiles for the users it serves and to provide the viewing habits of those users to the command and control unit 1.

FIG. 3 is a block diagram illustrating in more detail the contents of the data switch 29. As shown, the data packets from the ATM switch 21 are received at an input network interface unit 31 which is shown in more detail in FIG. 4. As shown, the input network interface unit 31 has a connector 51 which provides the physical interface to the ATM switch 21. The received data packets pass through the connector 51 to an input network controller 53 which examines the header of each data packet to determine if the data packet relates to a video stream or if it relates to a user request. If the data packet relates to a user request, then the input network controller 53 outputs the data packet to the control processor 33 via the control line 55. If the data packet relates to a video stream then the particular video stream to which the data packet belongs is determined from the header and then the data from the packet is extracted and stored in a slot of the input interface buffer 57 dedicated for that video data stream. In particular, the input interface buffer 57 is pre-configured to have a slot for up to M video data streams (S₁ to S_{M}). Since some of the data packets might be received in a different order to the order in which they were transmitted (due to the asynchronous nature of the link between the command and control unit 1 and the central office 5), the input network controller 53 re-orders the packets if necessary. The input network controller 53 also performs error checking and correction on each data packet.

In this embodiment, each slot of the input interface buffer 57 can hold typically tens or hundreds of milliseconds of video data depending on the data rate of the video streams, the network latency etc. The data in each slot of the input interface buffer 57 is then read out in blocks of a predetermined (fixed) block size (which may or may not correspond to the block size of the video data within each video data packet) by a data blocker and tagging unit 59. In this embodiment, the size of the slots in the buffer are big enough to hold several of these blocks of data so that the buffer 57 can handle the reception of bursts of video data for each stream. Each block read out by the data blocker and tagging unit 59 is tagged with a number (N) identifying the number of users currently watching the video stream to which the data belongs. This information is obtained from the control processor 33 which keeps track of which users are watching each video stream from the received user requests. This tagging information is provided from the control processor 33 to the input network controller 53 which then passes it to the data blocker and tagging unit 59 via the buffer 57. Once a data block has been tagged in this way, it is stored in a respective slot of the buffer 35 shown in FIG. 3 which is a one read port one write port buffer. This buffer 35 has a similar structure to the input interface buffer 57 in that it has M separate slots for receiving the data blocks of M different video streams. In practice, however, the command and control unit 1 will not transmit all M video data streams at the same time. Some video streams may only be transmitted intermittently and some of the slots may be provided for future expansion of the system.

FIG. 5 is a schematic block diagram illustrating the way in which the buffer 35 is partitioned into the M slots 71-1 to 71-M. Further, in this embodiment as shown in FIG. 5 by the exploded view of slot 71-4, each slot has storage locations 73-1 to 73-3 for up to three data blocks, each of which has a data portion 75-1 to 75-3 having the video data for the block and a tag portion 77-1 to 77-3 having the number (N) of users currently watching that stream (and hence the number of users who are to receive the video data in that block). The writing of the data blocks into the buffer 35 by the blocker and tagging unit 59 is controlled by a buffer write address pointer (not shown) associated with each slot 71. This pointer is incremented each time a block of data is written into the corresponding slot of the buffer 35 and operates to repeatedly cycle through the three storage locations 73 in the corresponding slot 71.

Returning to FIG. 3, at the same time that the input network interface unit 31 is writing the data blocks into the buffer 35, the distributor 37 cycles through each slot 71 in the buffer 35 and sends a current data block 75-j from each slot to the appropriate users via the output network interface unit 39. The information detailing which users are to receive which video streams is provided to the distributor 37 by way of a mapping table 41 which is generated and kept up to date by the control processor 33 from the received user requests. In particular, the mapping table 41 identifies, for each user, the video stream that that user is to receive. In this embodiment, the entries in the mapping table 41 are ordered so that users receiving the same video data stream are grouped together as consecutive entries in the table. The entries are also arranged in order of the video data stream number, so that the entries for video data stream S₁ come before the entries for video data stream S₂ etc. As will become apparent from the more detailed description of the distributor 37 given below, the ordering of the entries in the mapping table 41 in this way minimises the processing required to process the mapping table 41 by the distributor 37. An illustration of the form of the mapping table used in this embodiment is given below in the following table.

TABLE

| ENTRY | STREAM BEING WATCHED | USER |
|---|---|---|
| 1 | C₄ | U₃ |
| 2 | C₄ | U₆ |
| 3 | C₄ | U₅ |
| 4 | C₅ | U₄ |
| 5 | C₅ | U₁ |
| 6 | C₇ | U₈ |
| 7 | C₉ | U₉ |
| 8 | C₉ | U₂ |
| 9 | C₉ | U₇ |
| . | . | . |
| . | . | . |
| . | . | . |

In order to distribute a data block to a user, the distributor 37 passes the data block 75 to the output network interface unit 39 together with the user number (e.g. U₄) for the user that is to receive the data block 75. FIG. 6 shows in more detail the main components of the output network interface unit 39. As shown, the data block and the user identifier are input to a data packetiser 81 which splits up the data in the block into smaller blocks suitable for transmission in IP data packets. These smaller blocks are then input to an output interface buffer 83. The data packetiser 81 also outputs the user identifier to the output network controller 85 via the output interface buffer 83. The output network controller 85 then retrieves the appropriate addressing information for that user from a stored look-up table (not shown) which identifies the relationship between the user identifier and the corresponding user's addresses (such as IP address, MAC (Medium Access Control) address and virtual circuit number). The output network controller 85 then processes each of the data blocks stored in the output interface buffer 83 to provide error correction encoding etc and to add the appropriate address headers. The packets thus generated by the output network controller 85 are then passed via the connector 87 back to the ATM switch 21. The ATM switch 21 then switches these IP packets to the appropriate user via the corresponding DSLAM 27.

The look-up table used by the output network controller 85 is provided to the output network interface unit 39 on the control line 89 from the control processor 33. This look-up table is generated and maintained by the control processor 33 from user profile data which is stored in the user database 43. The control processor 33 also uses the data stored in the user database 43 in order to control access to the video streams by the users. In particular, each time a request for a video channel is received from a user, the control processor 33 checks the user profile for that user which is stored in the user database 43 to ensure that the user is entitled to receive the requested video stream. If the user is entitled to receive the stream, then the control processor 33 updates the mapping table 41, otherwise it does not and it sends an appropriate error message back to the user. The control processor 33 is also operable to control the initialisation of the buffer 35 as and when required either via the control line 44 or indirectly via the input interface unit 31.

As will be apparent from the above description, one of the important processing elements of the data switch 29 is the distributor 37. It must cycle through the slots 71 in the buffer 35 extracting data for onward transmission to the users. In order that the distributor 37 can operate as efficiently as possible, it is designed, in this embodiment, to operate independently without interruption by the input network interface unit 31 or the control processor 33. In order that the distributor 37 can operate without interfering with the input network interface unit 31, they are arranged so that they will not try to read data from/write data to the same buffer address at the same time and in order to ensure that the distributor 37 is not interrupted by the operation of the control processor 33, two mapping tables are used by the data switch 29—a current mapping table and a next mapping table. The distributor 37 uses the current mapping table whilst it cycles through the slots 71 in the buffer 35 and whilst this is happening, the control processor 33 updates the next mapping table in response to received user requests. Once the distributor 37 completes one cycle of the buffer 35, it copies the next mapping table as the current mapping table and then the distributor 37 begins the next processing cycle of the buffer 35 using the thus updated current mapping table.

A more detailed description of the way in which the distributor 37 operates in this embodiment will now be given with reference to FIGS. 7 and 8.

### Distributor

FIG. 7 is a block diagram illustrating the main components of the distributor 37 used in this embodiment. As shown, the distributor 37 includes a distributor control unit 91 which coordinates and controls the operation of the other elements of the distributor which include: a buffer reader 93 for reading data from the buffer 35; a buffer address selector 95 for providing the appropriate address for the next block of data to be read from the buffer 35; and a mapping table reader 97 for reading entries from the current mapping table 41. The operation of the distributor 37 shown in FIG. 7 will now be described with reference to the flowchart shown in FIG. 8.

As shown, in step S₁, the distributor control unit 91 initialises a loop pointer (i) used to loop through each of the slots 71 (and hence each of the video streams) in the buffer 35. In this embodiment, i is initially set to the value of 1 so that the initial video stream to be processed is stream S₁ from slot 71-1. The processing then proceeds to step S2 where the distributor determines whether or not a block is available for the current stream Sᵢ. The distributor does this by checking the current buffer address read pointer (j) for the current slot 71-i (which points to the storage location 73 within the current slot 71-i from which the distributor 37 is to read data) with the current buffer address write pointer used to point to the storage location 73 in the current slot 73-i into which the input network interface unit 31 is writing data. The buffer address selector 95 maintains the value of the current read pointer for the current slot 71-i and the current write pointer for the current slot 71-i is stored in that slot of the buffer 35. If the distributor control unit 91 determines that the read pointer and the write pointer are pointing to the same storage location 73 then there is no data block to be processed for the current stream Si and the processing proceeds to step S9 (which will be described below).

If on the other hand the distributor control unit 91 determines that the read pointer and the write pointer are pointing to different storage locations 73, then the processing proceeds to step S3 where the buffer reader 93 is instructed to retrieve the number of users (N) watching the current video stream Sᵢ from the storage location 73 pointed to by the read pointer (j) of the current slot 71-i. The processing then proceeds to step S5 where the distributor control unit 91 determines whether or not N equals zero (i.e. whether or not anybody is watching the current video stream Sᵢ). If no-one is watching the current video stream then the processing proceeds to step S7 where the current block of data 75-j is effectively discarded from the buffer 35. As shown in step S7, this is achieved by simply incrementing the current buffer address read pointer (j) associated with stream Si internally within the buffer address selector 95, so that the next time the distributor 37 processes video stream Sᵢ it will read data from the next storage location 73 from that slot 71. In fact, since there are only three storage locations 73 in each slot 71 in this embodiment, j will only be incremented up to a value of three and then at the next increment it will be set to a value of 1 again. In this way, the buffer address selector 95 causes the distributor 37 to cycle through the three buffer locations 73 within each buffer slot 71. The processing then proceeds to step S9 where the loop pointer i is incremented by 1 and then proceeds to step S11 where the distributor control unit 91 compares the current value of the loop pointer i with the maximum number of slots in the buffer M (which corresponds to the maximum number of video streams which can be processed by the data switch). Provided the loop pointer i is less than M, the processing returns to step S3 so that a similar process is performed on the next data stream in the next slot 71 of the buffer 35.

If at step S5 the distributor control unit 91 determines that one or more users are watching the current video stream Sᵢ (i.e. N does not equal zero), then the processing proceeds to step S13 where the distributor control unit 91 instructs the mapping table reader 97 to search the mapping table to find the first entry that is associated with the current video stream Sᵢ being processed. The processing then proceeds to step S15 where the distributor control unit 91 checks to see whether or not such a first entry has been found. Step S15 is needed since it is possible that the mapping table 41 may be updated to remove all of the entries for the current video stream before all of the old data blocks for that stream have been distributed by the distributor 37. If the mapping table reader 97 does not find an entry in the current mapping table 41 for the current stream Sᵢ, then the processing returns to step S7 where the current block of data 75-j is again discarded from the buffer 35.

If at step S15 a first entry is found within the mapping table 41, then the processing proceeds to step S17 where the distributor control unit 91 retrieves the current data block 75-j for the current video stream Sᵢ from the buffer 35 and passes it to the output network interface unit 39 together with the “CURRENT USER NUMBER” for the user found at the current entry in the mapping table 41. The processing then proceeds to step S19 where the distributor control unit 91 causes the mapping table reader 97 to retrieve the next entry from the mapping table (i.e. the entry immediately after the last entry that was retrieved). The video stream of this entry is set as “NEXT STREAM” and the user number is set as “NEXT USER NUMBER”. The processing then proceeds to step S21 where the distributor control unit 91 checks to see whether or not “NEXT STREAM” is the same as the current video stream being processed. If it is, then the processing proceeds to steps S23 and S25 where “CURRENT USER” is set to “NEXT USER NUMBER” and where “CURRENT ENTRY” is set as “NEXT ENTRY” respectively. The processing then returns to step S17 so that the same data 75-j from the same slot can then be transmitted to this new user. Once the distributor control unit 91 determines that “NEXT STREAM” is not the same as “CURRENT STREAM” the processing proceeds from step S21 back to step S17 where again the current data block 73-j is effectively deleted by incrementing the buffer address read pointer j for the current stream Sᵢ being processed.

This routine then continues until each slot 71 within the buffer 35 has been processed at which point the loop pointer i will be incremented in step S9 so that it has a value of M+1 and therefore the processing will proceed from step S11 to step S27. In step S27 the distributor control unit 91 checks if the processing should stop (e.g. because an error has occurred) or if it should continue. If it is to continue then the processing proceeds to step S29 where an appropriate wait state is introduced. This wait state is required in order to ensure that the distributor 37 distributes the data to the various users at a rate which corresponds to the maximum rate at which data is being written into the buffer 35. In particular, the rate at which the distributor 37 cycles through the data within the buffer (i.e. passes from processing step S1 through the flowchart shown in FIG. 8 back to step S1) must correspond to the rate at which new blocks are being written into the buffer for the video stream having the highest data rate. In this embodiment, the data rates of each of the channels is known in advance to the control processor 33 (from management data received from the command and control unit 1), and therefore the control processor 33 configures the distributor 37 so that it only allows the processing to proceed from step S29 to step S31 after a predetermined period has elapsed since the last cycle was started. After step S29, the processing then proceeds to step S31 where the distributor control unit 91 causes the mapping table reader 97 to copy the next mapping table as the current mapping table so that the next time the distributor 37 cycles through each of the video streams, any changes of which video stream each user wishes to view will be taken into account.

### Alternative Embodiments

In the above embodiment, the distributor 37 cycled through the slots 71 in the buffer 35, accessing the mapping table 41 where appropriate. Alternatively, the distributor 37 may access the mapping table 41 as the primary control data structure and then access the slots 71 in the buffer 35 according to the entries in the mapping table 41. The way in which such an embodiment would operate will now be described with reference to FIG. 9.

Initially, in step S51, the distributor control unit 91 causes the mapping table reader 97 to read the first entry from the current mapping table 41 to obtain the current stream and the current user number from that entry. The processing then proceeds to step S52 where the current block of data for streams sᵢ to sᵢ₋₁ are deleted from the buffer 35 by incrementing the corresponding buffer address read pointers (j). However, this is done for these streams only if a data block exists for the stream. In particular, if the read pointer (j) points to the same storage location 73 as the write pointer then the read pointer is not incremented for that stream. The processing then proceeds to step S53 where the distributor control unit 91 retrieves the appropriate buffer address read pointer for the slot 71 associated with the current stream from the buffer address selector 95. The distributor control unit 91 then instructs the buffer reader 93 to retrieve the data block from that slot 71 in the buffer 35 and passes the data block to the output network interface unit 39 together with the current user number retrieved in step S51.

The processing then proceeds to step S55 where the distributor control unit 91 checks to see whether or not the current entry being processed is the last entry in the mapping table. If it is not then the processing proceeds to step S57 where the distributor control unit 91 reads the next entry (i.e. the entry immediately following the entry that was just processed) from the mapping table 41 to obtain the next stream and the next user number from that entry. The processing then proceeds to step S59 where the distributor control unit 91 sets CURRENT USER as NEXT USER. The processing then proceeds to step S61 where the distributor control unit 91 checks to see if NEXT STREAM is the same as CURRENT STREAM. If it is, then the processing returns to step S53 so that the data can be read again from the buffer 35 and output to the new current user. If, however, the distributor control unit 91 determines at step S61 that NEXT STREAM is not the same as CURRENT STREAM then the processing proceeds to step S63 where the distributor 37 effectively deletes the current data block from the current slot 71 being processed and the current data block for the streams between the current stream and the next stream. As in the first embodiment, this is achieved simply by incrementing the buffer address read pointer (j) associated with each of those streams (provided the read pointer is not pointing to the same storage location 73 as the write pointer). The processing then proceeds to step S65 where CURRENT STREAM is set as NEXT STREAM and then the processing returns to step S53 where the operation can be repeated except reading from the slot 71 associated with the new current stream.

The above processing continues until all of the entries in the mapping table 41 have been processed in this way. The processing then proceeds from step S55 to step S67 where the distributor control unit 91 checks to see whether or not the processing should stop. If it is not to stop then the processing continues to step S69 where the buffer address selector 95 increments the current buffer address read pointer (j) associated with the current stream that was just processed thereby effectively deleting the corresponding data block from the slot 71 in the buffer 35. The processing then proceeds to step S71 where the mapping table reader 97 copies the next mapping table to the current mapping table. The processing then proceeds to step S73 where an appropriate wait time is introduced into the processing cycle of the distributor 37 in order to ensure that it processes the data at the same rate that the data is being written into the buffer 35 by the input network interface unit 31. The processing then returns to step S51 where the processing commences again.

As those skilled in the art will appreciate from the above description, the systems described above provide an efficient technique for receiving a number of incoming broadcast streams, selecting the streams of interest and distributing them to the appropriate users. The selection of the streams of interest and the distribution is efficiently performed by a local mechanism in response to external commands. The result is that a relatively small number of incoming streams S_{MAX} can be efficiently distributed to a much larger number of users U_{MAX}. In addition, the embodiments described above provide a more secure way of delivering content to the end user than the prior art, since each user does not receive all of the broadcast streams and the control mechanism for allowing access to each stream to be delivered is not located at the end user's premises but is located at a remote location. As a result, unauthorised users cannot easily gain access to the content via appropriate hacking equipment.

Another advantage of the distributed nature of the data distribution systems described above is that they allow the personalisation of the individual user data streams, whilst not significantly increasing the bandwidth required between the command and control unit 1 and the central offices 5. The way in which this may be achieved will now be described in a system which allows the insertion of personalised adverts within the individual user video streams.

FIG. 10 is a block diagram illustrating the main components of the data switch 29 used in this embodiment in which a local advert store 121 is provided for storing adverts for insertion into video data streams in order to customise the video data stream received by each user. The components of the data switch 29 which are the same as those in the first embodiment have been labelled with the same reference number and their operation will not be described again. There are a number of ways in which the data for the adverts may be input into the advert store 121, such as by CD, DVD or through some other separate data input device. However, in this embodiment, the adverts are delivered to the advert store 121 via the input network interface unit 31 and an advert playout system 123. In particular, in this embodiment, a separate data stream is provided between the command and control unit 1 and each of the central offices 5 for downloading adverts to the data switch 29 in each central office 5. Further, the data rates of these additional channels do not need to be as high as the data rates of the video streams since adverts will only be played a relatively small part of the time. The advert data does not, therefore, have to be streamed continuously to each of the central offices 5. For example, the ratio of input advertising bandwidth to input broadcast bandwidth can be determined by dividing the number of minutes of advertising material by the number of minutes of non-personalised material (i.e. the video data streams) and then by dividing this with the maximum number of users that the data switch 29 serves. This ratio can be increased by grouping users into categories and playing the same adverts to the users in each category and/or by repeating each advert one or more times.

In operation, when the input network interface unit 31 receives data packets for an advert, it passes them to the advert playout system 123 on the control line 125. The advert playout system 123 then stores the adverts into the advert store 121 for future playout. In addition, the advert playout system 123 also receives user profile data from the control processor 33 on the control line 127. This profile data allows the advert playout system 123 to identify an appropriate advert to be played for each user. This is preferably pre-computed so that the advert playout system 123 has a list (not shown) detailing which advert should be played next for each user that the data switch 29 serves.

In this embodiment, some but not all of the video data streams include adverts. The breakpoints between the video programs and the adverts are identified by appropriate advert break data packets or other in-band or out-of-band data. When the input network interface unit 31 receives, for example such an advert break packet for one of the streams Si, the input network interface unit 31 informs the advert playout system that an advert break has started for that stream (Sᵢ). Additionally, in this embodiment, the distributor 37 informs the advert playout system 123 on control line 128 which slot 71 it is currently processing within the buffer 35. This informs the advert playout system 123 which video stream the distributor 37 is currently processing which it checks against the stream numbers provided by the input network interface unit 31. When the advert playout system 123 determines that the distributor 37 is processing a video stream which is in an advert break, it outputs a control signal on control line 129 to control the operation of the multiplexer 131. In particular, the multiplexer 131 is arranged to normally pass the data output from the distributor 37 directly to the output network interface unit 39. However, when it receives the control signal on control line 129, it connects the advert store 121 to the output network interface unit 39 rather than the distributor 37. Subsequently, when the distributor 37 outputs the data and the user number (for example in response to step S17 shown in FIG. 8) the user number is passed via the control line 133 to the advert playout system 123. In response, the advert playout system 123 determines the appropriate advert to be played from its stored list and instructs the advert store 121 to output the appropriate block of advert data for that advert together with the user number for that block. This data then passes through the multiplexer 131 to the output network interface unit 39 where the data is processed as before. As a result, targeted adverts are inserted over existing adverts within the video data stream, thereby customising the video data stream for that user. Various transition effects may also be added between adverts such as fading to and from a black screen, fading in and out of audio or the insertion of an appropriate logo. The system therefore achieves similar results to conventional advertisement re-insertion equipment except that it allows the techniques to be efficiently applied to stream counts which are orders of magnitude greater than that achievable using the conventional equipment.

In addition to being able to insert personalised adverts for each of the users, the data switch 29 can also be modified to include a suitable hard disc (or other memory device) so that each of the users can, for example, pause their video stream. The way in which this may be achieved will now be described with reference to FIG. 11. The components of the data switch 29 which are the same as the components of the data switch 29 used in the previous embodiment are labelled with the same reference number. As shown in FIG. 11, the data switch 29 has been modified to include a hard disc 141 and a playout control system 143. In operation, when the control processor 33 receives a request from a user to pause the current video stream that the user is currently receiving, the control processor 33 checks the next mapping table to see which stream Sᵢ that user Uₖ is receiving. The control processor 33 then outputs this information (Sᵢ, Uₖ and the requested action) to the playout control system 143 via the control line 145. The playout control system 143 then monitors the output from the distributor 37 via the control line 149 to check when output data is to be transmitted to user Uₖ. When the output data from the distributor 37 is not for user Uₖ the playout control system 143 outputs a control signal on control line 151 to cause the multiplexer 131 to pass the data output from the distributor 37 directly to the output network interface unit 39 as before. However, when the data is for user Uₖ, the playout control system 143 stores the data in the hard disc 141 and outputs a control signal on line 151 in order to connect the hard disc 141 to the output network interface unit 39 through the multiplexer 131. In this embodiment, the user device 11 is arranged to freeze the current frame displayed to the user. This avoids the need for the hard disc to repeatedly output the same data in order to repeat the current video frame which is delivered to the user. This process then continues until a further user request is received requesting the video data stream to start replaying again from the point at which it was paused. In response to receiving such a request, the playout control system 143 ensures that the hard disc 141 outputs the appropriate data blocks to that user whilst at the same time storing the real time video data blocks for that stream which are received whilst the recorded video stream is being played out.

As those skilled in the art will appreciate, in addition to the pause and restart requests, the user may also ask, for example, to fast-forward or rewind through the stored video stream or to return back to the original live video stream as it is received by the data switch 29. In either case, the playout control system 143 will receive the appropriate command from the control processor 33 and will take the necessary action in controlling the storing and output of the data from the hard disc 141.

In addition to being able to personalise each data stream, the data switch 29 can also change the encoding format of one or more of the data streams. This is particularly useful where, for example, the command and control unit 1 transmits all of the video data streams in MPEG 4 or DVB (Digital Video Broadcast) format whilst one or more of the user devices 11 can only decode data streams in, for example, MPEG 2 format. The appropriate encoding translation can be performed at various stages within the data switch 29 but is most conveniently performed either in the input network interface unit 31 or in the output network interface unit 39. FIG. 12 is a block diagram of the input network interface unit 31 which may be used in such an embodiment. As shown, an encoding translator 161 has been provided between the input interface buffer 57 and the data blocker and tagging unit 59. The encoding translator 161 may operate on all of the received streams or on selected ones based on an appropriate control signal received from the input network controller 53. The encoding translator 161 may be arranged to translate from a single input encoding standard to a single output encoding standard. Alternatively, it may be arranged to be able to translate any number of different input encoding formats into a number of different output encoding formats. The way in which the translation is performed is conventional and will not be described in more detail here.

### MODIFICATIONS

A number of embodiments have been described above which illustrate the way in which a data switch can be used to receive a number of incoming broadcast streams and to distribute the broadcast streams to a number of users in accordance with their requests. Whilst the embodiments described above have been specific, it will be apparent to those skilled in the art that a number of modifications can be made to these embodiments. Some of these modifications will now be described for illustration.

In the above embodiments, the data distribution system was used to distribute video streams from a command and control unit 1 to a number of remote user devices. As those skilled in the art will appreciate, the above system architecture and data switch can be used to distribute different types of streamed data, such as audio data or financial data such as the financial data provided by Reuters.

Whilst the above embodiments have described the operation of the data switch within the context of an IP packet-based data network, this is not essential. It does not matter how the data is transmitted to the data switch or how it is then delivered from the data switch to the users. For example, the data may be transmitted to the switch via satellite or via some other data network such as a switched Ethernet network and the data may then be transmitted to the end users via wireless links. Further, it is not essential to have a distributed architecture such as the one illustrated in FIG. 1. The data switch may be placed at any point in the communications system such as on the left hand side of the command and control unit or the left hand side of the communications channel. It may be provided as a separate box next to the ATM switch or it may be physically embodied as a circuit board which may be inserted into, for example, the ATM switch, the IP router or the DSLAMs. The data switch may also be provided later in the communications link either at a street-side hub or even in each of the user devices.

In the first embodiment described above, a separate address read pointer and a separate address write pointer for each slot within the buffer were used to control the writing of data to and from the buffer. Whilst this allowed the system to be able to write data to and read data from different address locations within each slot during any one processing time, it requires separate address pointers for each slot (both for the reading and for the writing process). In a simpler embodiment in which the data rate of all of the received streams is the same, a single address read pointer may be used for the distributor and a single address write pointer may be used for the input network interface unit so that at any one time the interface unit writes data to the same address within each slot and the distributor reads data from the same address within each slot. In this case, the flowchart shown in FIG. 8 would be modified to move processing step S7 to, for example, between steps S29 and S31.

In the embodiments described above, the distributor read out the data from the buffer and then passed it through to the output network interface unit. In practice, this may be achieved without the data having to pass through the distributor unit itself. For example, a common output bus from the buffer may be connected both to the distributor and to the output network interface unit, with the distributor applying the appropriate addresses to the buffer to control the reading of the data out therefrom.

In the above embodiments, the data for each data stream was stored in contiguous addresses of the buffer memory. As those skilled in the art will appreciate, this is not essential. All that is needed is that the input network interface unit writes the data blocks for each of the data streams to memory locations which are known to the distributor. This knowledge is preferably pre-stored within the distributor in order to maximise the speed at which the distributor can operate. However, if speed is not so important then the input network interface unit may dynamically tell the distributor where it has stored each data block.

In the above embodiment, the buffer was shown as a single buffer which was notionally divided into M slots, with each slot having three locations for data blocks. As those skilled in the art will appreciate, this is not essential. The buffer may be constituted by any number of separate buffer chips or it may form part of a larger integrated circuit. The number of storage locations within each slot may also be varied but should be at least two to allow the distributor to operate independently from the input network interface unit.

In the above embodiments, the mapping table was arranged so that entries corresponding to the same data stream were grouped together. The entries were also arranged in increasing stream number order. As those skilled in the art will appreciate, this is not essential but is used in order to minimise the time required by the distributor to search the mapping table to retrieve the appropriate entries.

In the above embodiments, the data switch received requests for specific data streams from the user and an appropriate data stream was then delivered to the user at the user's corresponding address. As those skilled in the art will appreciate, it is not essential that the request for the data stream comes from the particular user to which the data stream is to be supplied. The request may come from a third party such as the command and control unit.

In the above embodiment in which adverts were inserted within the data streams, the system may be further enhanced to provide the ability to enable users to interact with their adverts. For example, the system may be adapted to allow users to request further information about a product being advertised. In this case, the data switch would retrieve the appropriate additional information from the advert store and transmit it to that user. At the same time, if the video broadcast resumes playing at the end of the advert break whilst the user is still receiving this additional information, the switch may be arranged to store the stream for the user until the user wishes to return to the video program.

In the above embodiments, the user requests were transmitted to the data switch over the same data channel through which the data stream is ultimately transmitted to the user. It is also received by the data switch through the input network interface unit. As those skilled in the art will appreciate, this is not essential. The requests made by the users may be transmitted to the data switch by any appropriate connection. For example, a direct RF radio link may be provided between the control processor and each of the user devices.

As a further improvement to the video switch discussed above, the switch may be modified to provide the ability for each of the users to interact with the storyline within the video program, for example, by choosing the way in which the story unfolds. This may be implemented, for example, by the command and control unit 1 transmitting all of the possible storylines to the regional offices and then the data switch simply selecting the appropriate stream in accordance with the user's interaction. Alternatively, the different storylines may be stored locally within the data switch with the appropriate storyline being output to the user from the local store in accordance with their interaction.

In the above embodiments, the data switch was provided inline between a command and control unit and the users who receive the different data streams. In an alternative embodiment, the data switch may be configured to form part of a larger unit delivering video on demand as well as broadcast TV. In this case, the incoming content would be stored locally to the data switch and played out on demand to the users. This could be developed further by providing the ability to store a number of preferred movies for each user so that the user can access those movies at any time.

In the above embodiments, a single data stream was directed to each end user. As those skilled in the art will appreciate, the above system may operate to transmit a plurality of data streams to each user, provided the bandwidth between the user and the regional office is sufficiently large to accommodate this. If there is limited bandwidth then such a system could use video statistical multiplexing which looks at the content of the video and which allocates bandwidth depending on the amount of action in the scene. This type of statistical multiplexing would then allow more than one channel to be used down a more limited bandwidth link.

In the above embodiments, the data switch is preferably formed from hardware circuits which may be formed from separate integrated circuits or which may form a single application-specific integrated circuit. However, this is not essential and one or more of the components of the data switch may be implemented as software run on a programmable computer device. The software may be in the form of source code, object code, a code intermediate source and object code such as in partially compiled form or in any other form suitable for use in the implementation of the process according to the invention. The software may be provided on a carrier such as a ROM or CD or a transmissible carrier such as an electrical or optical signal which may be conveyed via electrical or optical cable or by radio or other means. preferred embodiment, the data switch receives a number of incoming broadcast streams, efficiently selects the streams of interest and distributes them to the appropriate users. The selection of the streams of interest and their distribution is efficiently performed by the data switch in response to external commands provided by, for example, the users.

1. A data switch for controlling the distribution of a plurality of data streams to one or more target devices, the data switch comprising:
an input interface unit for receiving the plurality of data streams;
a buffer operable to receive and store data for each of the received data streams from the input interface unit;
a memory operable to store distribution data identifying which one or more data streams should be distributed to the or each of said target devices; and
a distributor responsive to said stored distribution data for cyclically processing the data in said buffer to distribute, during each processing cycle, portions of said data streams to said one or more target devices in accordance with the stored distribution data.

2. A data switch according to claim 1, wherein said input interface unit is operable to group the data for each data stream into blocks of data and to store the blocks at predetermined memory locations within said buffer and wherein said distributor is operable to read said blocks from said predetermined memory locations during the distribution of said data streams to said one or more target devices.

3. A data switch according to claim 2, wherein said input interface unit is operable to group the data for each data stream into fixed sized blocks.

4. A data switch according to claim 2, wherein said input interface unit comprises a memory operable to store data from the plurality of received data streams and a processor operable to process the data within said memory to form said blocks of data and to output said blocks of data to said buffer.

5. A data switch according to claim 2, wherein said input interface unit further comprises a tagger operable to tag each block of data with data identifying the number of target devices to which the block of data is to be distributed.

6. A data switch according to claim 1, wherein said input interface unit is operable to receive said plurality of data streams as a plurality of data packets each packet having data for the stream and a header identifying the stream to which the data belongs and wherein the input interface unit is operable to remove said header from each packet and to store the data from each packet within a portion of the buffer associated with the corresponding data stream.

7. A data switch according to claim 1, wherein said buffer comprises a single buffer memory.

8. A data switch according to claim 7, wherein said buffer memory has a single read port and a single write port connected respectively to said distributor and said input interface unit.

9. A data switch according to claim 1, wherein said buffer comprises a plurality of buffer areas, each associated with a respective one of said data streams and operable to store plural portions of data from the corresponding data stream.

10. A data switch according to claim 9, wherein said input interface unit and said distributor are arranged to write data to and read data from different portions of each buffer area in an interleaved manner.

11. A data switch according to claim 1, wherein said distributor is arranged to distribute the data in said buffer to said target devices at a rate governed by the data rate of the data stream having the highest data rate.

12. A data switch according to claim 11, comprising a setter operable to set a wait state of said distributor during each processing cycle of said buffer.

13. A data switch according to claim 12, wherein said setter is operable to set the wait state so that the rate of said cyclic processing of said distributor is substantially the same as the rate at which blocks of data from the data stream having the highest data rate are stored in said buffer.

14. A data switch according to claim 12, wherein said setter is operable to introduce an appropriate wait state between each cycle of said cyclic processing of the data within said buffer.

15. A data switch according to claim 1, wherein said distributor is operable to read data from said buffer independently of the writing of data to said buffer by said input interface unit.

16. A data switch according to claim 1, wherein said distributor is operable to cycle through the data portions within said buffer and for each entry to retrieve distribution data identifying the target devices to which the data portion is to be distributed.

17. A data switch according to claim 1, wherein said distributor is operable to cycle through the distribution data and to retrieve the data from the buffer corresponding to each entry of the distribution data.

18. A data switch according to claim 1, further comprising a controller operable to receive a request identifying a data stream to be transmitted to a target device and operable to update said distribution data in accordance with said received request.

19. A data switch according to claim 18, wherein said distributor is operable to process said distribution data independently of said controller.

20. A data switch according to claim 19, wherein said distribution data comprises a current distribution list identifying which one or more data streams should be distributed to the or each of said target devices at a current time-point and a next distribution list identifying which one or more data streams should be distributed to the or each of said target devices at a next time-point; wherein said distributor is operable to process the data in said current distribution list, wherein said controller is operable to update said next distribution list in dependence upon the received request and wherein said distributor is operable to replace intermittently said current distribution list with said next distribution list.

21. A data switch according to claim 20, wherein said distributor is operable to replace said current distribution list with said next distribution list at the end of each cyclic processing of said buffer.

22. A data switch according to claim 18, wherein said controller comprises a validator operable to validate each request with pre-stored profile data associated with a user and operable to identify the one or more data streams which may be transmitted to the corresponding target device.

23. A data switch according to claim 1, further comprising an output interface unit operable: (i) to receive each data portion distributed by said distributor together with data identifying the target device to which the data is to be transmitted; and (ii) to transmit said data portion to said target device.

24. A data switch according to claim 23, wherein the data identifying the target device to which the data portion is to be transmitted comprises an identifier and wherein said output interface unit comprises address data identifying the transmission address for each target device and wherein said output interface unit is operable, upon receipt of a data portion and a target device identifier, to determine a transmission address from said address data using said target device identifier and to transmit said data portion to said determined transmission address.

25. A data switch according to claim 23, wherein said output interface unit is operable to divide each data portion into a plurality of subportions and is operable to transmit each subportion in a data packet having a header with a transmission address to which the data should be transmitted.

26. A data switch according to claim 1, further comprising a data modifier operable to modify the data stream distributed to said one or more target devices to form a personalised data stream.

27. A data switch according to claim 26, further comprising a local data store for storing personalised data to be inserted within said data streams and wherein said modifier is operable to modify said one or more data streams distributed to the or each target device by inserting personalised data from said local data store within the or each data stream.

28. A data switch according to claim 27, further comprising a selector operable to select the personalised content data from said local data store for insertion into said one or more data streams.

29. A data switch according to claim 27, wherein said personalised content data is representative of one or more adverts.

30. A data switch according to claim 1, further comprising a local data store for storing data and a receiver operable to receive a request to pause a data stream being transmitted to a target device and wherein upon receipt of such a pause request, the data stream being transmitted to that target device is stored in said local data store.

31. A data switch according to claim 30, further comprising a controller operable to control the rate at which data is subsequently read out from said local data store.

32. A data switch according to claim 1, wherein one or more of said data streams are encoded in accordance with a first encoding technique and wherein the data switch further comprises a converter operable to convert the encoding format of said one or more encoded data streams.

33. A data switch according to claim 32, wherein said converter forms part of said input interface unit.

34. A data switch for controlling the distribution of a plurality of data streams to one or more target devices, the data switch comprising:
an input interface unit operable to receive the plurality of data streams;
a buffer operable to receive and to store data from each of the received data streams from the input interface unit;
a memory operable to store distribution data identifying which one or more data streams should be distributed to the or each of said target devices;
a distributor responsive to said stored distribution data for processing the data in the buffer to distribute the data streams to said one or more target devices in accordance with the stored distribution data;
wherein said input interface unit is operable to group the data for each data stream into fixed sized blocks and to store the blocks for each data stream at predetermined memory locations within said buffer; and
wherein said distributor is operable to read said blocks from said predetermined memory locations within said buffer during the distribution of said data streams to said one or more target devices.

35. A data switch for controlling the distribution of a plurality of data streams to one or more target devices, the data switch comprising:
an input interface unit operable to receive the plurality of data streams;
a buffer operable to receive and store data from each of said received data streams from the input interface unit;
a first memory operable to store a current distribution list identifying which one or more data streams should be distributed to the or each of said target devices at a current time point;
a second memory operable to store a next distribution list identifying which one or more data streams should be distributed to the or each of said target devices at a next time point;
a distributor responsive to the current stored distribution list for processing the data in the buffer to distribute the data streams to said one or more users in accordance with the current stored distribution list;
a control processor operable to receive a request to change which one or more data streams should be distributed to one or more of said target devices and operable to amend said next distribution list in accordance with the received request; and
a setter operable to intermittently set said next distribution list as said current distribution list to cause said distributor to change the way in which said data streams are distributed to said one or more target devices in accordance with said received request.

36. A data switch for controlling the distribution of a plurality of personalised data streams to one or more target devices, the data switch comprising:
an input interface unit operable to receive a plurality of data streams;
a buffer operable to receive and store data from each of the received data streams from the input interface unit;
a memory operable to store distribution data identifying which one or more data streams should be distributed to the or each of said users;
a distributor responsive to said stored distribution data for processing the data in the buffer to distribute the data streams to said one or more target devices in accordance with the stored distribution data;
a local data store operable to store personalised data to be inserted within said data streams; and
a personaliser operable to insert personalised data from said local data store within the or each data stream distributed to said one or more target devices.

37. A data distribution system for distributing a plurality of personalised data streams to one or more target devices, the system comprising:
a command and control unit and a plurality of regional central offices;
the command and control unit being operable to transmit a plurality of common data streams to each of said regional central offices; and
wherein each of said regional central offices comprises:
a receiver operable to receive the plurality of common data streams from said command and control unit;
a data switch operable to distribute a selected one or more of said data streams to the one or more target devices;
a first memory operable to store distribution data identifying which one or more of said data streams should be selected for distribution to the or each of said target devices;
a second memory operable to store personalised data content; and
a selector operable to select and to insert personalised content data from said second memory into said selected one or more data streams to be distributed to the or each of said target devices.

38. An Internet switch comprising:
an ATM switch for receiving IP data packets and streamed data packets for a plurality of data streams;
a data switch for receiving the streamed data packets from the ATM switch and for distributing a selected one or more of said data streams to one or more target devices; and
an IP router for receiving said IP data packets from said ATM switch and for processing said IP data packets to identify their destination and to route the data packets towards the identified destination;
wherein said data switch is operable to receive said streamed data packets and to distribute said streamed data packets to said one or more target devices in accordance with a stored distribution list which identifies which one or more data streams should be distributed to the or each of said target devices.

39. A method of controlling the distribution of a plurality of data streams to one or more target devices, the method comprising:
receiving the plurality of data streams;
storing data for each of the received data streams in a buffer;
storing distribution data identifying which one or more data streams should be distributed to the or each of said target devices; and
cyclically processing the data in said buffer using said distribution data to distribute, during each processing cycle, portions of said data streams to said one or more target devices in accordance with the stored distribution data.

40. A method according to claim 39, further comprising grouping the data for each data stream into blocks of data and storing the blocks at predetermined memory locations within said buffer and wherein said processing step reads said blocks from said predetermined memory locations during the distribution of said data streams to said one or more target devices.

41. A method according to claim 40, wherein said grouping step groups the data for each data stream into fixed sized blocks.

42. A method according to claim 40, further comprising tagging each block of data with data identifying how many target devices are to receive the block of data.

43. A method according to claim 39, wherein said receiving step receives said plurality of data streams as a plurality of data packets each packet having data for the stream and a header identifying the stream to which the data belongs and further comprising the steps of removing said header from each packet and storing the data from each packet within a portion of the buffer associated with the corresponding data stream.

44. A method according to claim 39, wherein said buffer comprises a plurality of buffer areas, each associated with a respective one of said data streams and operable to store plural portions of data from the corresponding data stream and wherein data is written into and read from different portions of each buffer area in an interleaved manner.

45. A method according to claim 39, wherein said processing step distributes the data in said buffer to said target devices at a rate governed by the data rate of the data stream having the highest data rate.

46. A method according to claim 45, further comprising setting a wait state of said processing step during each processing cycle of said buffer.

47. A method according to claim 46, wherein said setting step sets the wait state so that the rate of said cyclic processing is substantially the same as the rate at which blocks of data from the data stream having the highest data rate are stored in said buffer.

48. A method according to claim 46, wherein said setting step introduces an appropriate wait state between each cycle of said cyclic processing of the data within said buffer.

49. A method according to claim 39, wherein said processing step reads data from said buffer independently of the writing of data to said buffer.

50. A method according to claim 39, wherein said processing step cycles through the data portions within said buffer and for each entry retrieves distribution data identifying the target devices to which the data portion is to be distributed.

51. A method according to claim 39, wherein said processing step cycles through the distribution data and retrieves the data from the buffer corresponding to each entry of the distribution data.

52. A method according to claim 39, further comprising receiving a request identifying a data stream to be transmitted to a target device and updating said distribution data in accordance with said received request.

53. A method according to claim 52, wherein said processing step processes said distribution data independently of said updating step.

54. A method according to claim 52, wherein said distribution data comprises a current distribution list identifying which one or more data streams should be distributed to the or each of said target devices at a current time-point and a next distribution list identifying which one or more data streams should be distributed to the or each of said target devices at a next time-point; wherein said processing step processes the data in said current distribution list, wherein said updating step updates said next distribution list in dependence upon the received request and further comprising intermittently replacing said current distribution list with said next distribution list.

55. A method according to claim 54, wherein said replacing step replaces said current distribution list with said next distribution list between each cyclic processing of said buffer.

56. A method according to claim 52, further comprising the step of validating each request with pre-stored profile data associated with a user and identifying the one or more data streams which may be transmitted to the corresponding target device.

57. A method according to claim 39, using an output interface unit operable: (i) to receive each data portion distributed by said processing step together with data identifying the target device to which the data is to be transmitted; and (ii) to transmit said data portion to said target device.

58. A method according to claim 57, wherein the data identifying the target device to which the data portion is to be transmitted comprises an identifier and wherein said output interface unit comprises address data identifying the transmission address for each target device and comprising the steps of determining a transmission address from said address data using said target device identifier and transmitting said data portion to said determined transmission address.

59. A method according to claim 57, further comprising dividing each data portion into a plurality of subportions and transmitting each subportion in a data packet having a header with a transmission address to which the data should be transmitted.

60. A method according to claim 39, further comprising modifying the data stream distributed to said one or more target devices to form a personalised data stream.

61. A method according to claim 60, wherein said modifying step modifies said one or more data streams distributed to the or each target device by inserting personalised data from a local data store within the or each data stream.

62. A method according to claim 61, further comprising selecting the personalised content data from said local data store for insertion into said one or more data streams.

63. A method according to claim 61, wherein said personalised content data is representative of one or more adverts.

64. A method according to claim 39, further comprising receiving a request to pause a data stream being transmitted to a target device and storing the data stream being transmitted to that target device in a local data store upon receipt of said pause request.

65. A method according to claim 64, further comprising controlling the rate at which data is subsequently read out from said local data store.

66. A method according to claim 39, wherein one or more of said data streams are encoded in accordance with a first encoding technique and wherein the method further comprises converting the encoding format of said one or more encoded data streams.

67. A method of generating a signal conveying a data stream for transmission to a target device, the method comprising:
receiving a plurality of data streams;
buffering data for each of the received data streams;
storing distribution data identifying which one or more data streams should be distributed to said target device;
cyclically processing the buffered data using said distribution data to generate the data stream to be transmitted to said target device; and
generating a signal for transmission to said user device carrying the generated data stream.

68. Computer readable medium storing computer executable instructions for causing a programmable computer device to carry out the method according to claim 39.

69. Computer executable instructions for causing a programmable computer device to carry out the method of claim 39.
